(19) United States
(12) Patent Application Publication
(10) Pub. No.: US 2012/0320624 A1
(43) Pub. Date: Dec. 20, 2012

(54) ILLUMINATING DEVICE AND DISPLAY DEVICE

(75) Inventors: Hiromasa Yamane, Osaka-shi (JP); Masahi Miwa, Osaka-shi (JP)

(73) Assignee: SHARP KABUSHIKI KAISHA, Osaka-shi, Osaka (JP)

(21) Appl. No.: 13/581,400

(22) PCT Filed: Mar. 31, 2011
(86) PCT No.: PCT/JP2011/058302

§ 371 Date: Aug. 27, 2012

(30) Foreign Application Priority Data
Apr. 22, 2010 (JP) 2010-098944

(51) Int. Cl. F21V 7/04; F21V 8/00

(52) U.S. Cl. 362/602; 362/611; 362/609

(57) ABSTRACT

An illuminating device includes a substantially rectangular light guide plate that includes at least one end face as a light incident surface, a frame that is arranged to surround the light guide plate, and a light source that is located between the light guide plate and the frame so as to face the light incident surface of the light guide plate. The light guide plate and the frame are integrally molded by two-color molding, and at least a part of the end faces of the light guide plate except for the light incident surface is spaced from the frame. Thus, the illuminating device can be made thinner and lighter without reducing the strength and the brightness.

### CROSS REFERENCE TO RELATED APPLICATIONS

This application is a national phase of PCT/JP2011/058302, filed Mar. 31, 2011 and claims priority to Japanese Application No. 2010-098944, filed Apr. 22, 2010.

### TECHNICAL FIELD

The present invention relates to an illuminating device, particularly an illuminating device including a light guide plate. The present invention also relates to a display device including the illuminating device.

### BACKGROUND ART

In recent years, a wide range of liquid crystal display devices has become increasingly thinner and lighter, including not only small liquid crystal display devices used in mobile equipment such as a portable telephone, a notebook computer, a PDA, etc., but also large liquid crystal display devices used in a television etc.

In the liquid crystal display device, an illuminating device (backlight device) is located on the back of a liquid crystal panel, and a user observes light that has been emitted from the illuminating device and passed through the liquid crystal panel.

The above illuminating device is broadly divided into a direct type and an edge-light type depending on the arrangement of a light source with respect to the liquid crystal panel. In the edge-light type, a light source is located opposite one end face around a light guide plate having a substantially rectangular light emission surface. The light emitted from the light source enters the end face of the light guide plate, emanates from the light emission surface, which is one of a pair of principal surfaces of the light guide plate, and illuminates the liquid crystal panel.

If the thickness and weight of the edge-light type illuminating device are reduced only by reducing the thickness and weight of each component of the illuminating device, a decrease in strength may be a problem. Therefore, a technique has been proposed that integrates the light guide plate with a frame, both of which are conventionally discrete components, by two-color molding (double molding) to reduce the thickness and the weight while preventing a decrease in strength.

For example, as shown in FIG. 5, Patent Document 1 discloses an illuminating device in which a frame 120 is integrally molded with a light guide plate 110 by two-color molding, so that the rectangular frame 120 is in close contact with the periphery of the light guide plate 110 without any gap between them. In FIG. 5, reference numeral 130 represents a linear light source that is located opposite the end face on the short side of the light guide plate 110, reference numeral 136 represents a reflecting sheet, and reference numeral 137 represents a photochromic sheet.

As shown in FIG. 6, Patent Document 2 discloses an illuminating device in which a frame 150 is integrally molded around a light guide plate 140 by two-color molding. A flange portion 141 is formed on the outer peripheral surface of the light guide plate 140, a flange receiving portion 151 is formed on the inner peripheral surface of the frame 150, and the upper surface of the flange portion 141 and the lower surface of the flange receiving portion 151 are joined together. A space 142 is formed between the edge of the flange portion 141 of the light guide plate 140 and the inner peripheral surface of the flame 150, and a space 152 is formed between the outer peripheral surface of the light guide plate 140 and the edge of the flange receiving portion 151 of the frame 150.

### PRIOR ART DOCUMENTS

### Patent Documents

Patent Document 1: JP 2008-84714 A
Patent Document 2: JPH10 (1998)-68826 A

### DISCLOSURE OF INVENTION

### Problem to be Solved by the Invention

When the frame is integrated with the light guide plate by two-color molding, as shown in FIGS. 5 and 6, the strength can be improved, but the brightness of the resultant illuminating device is reduced, compared to the case where the light guide plate and the frame that have been separately produced are assembled into one unit. This will be described with reference to FIGS. 7A and 7B.

FIG. 7A shows an optical path of light emitted from a light source (e.g., an LED) 180 in a conventional illuminating device obtained by the assembly of a light guide plate 160 and a frame 170 that have been separately produced. In this illuminating device, a space 185 is formed between an end face 161 around the light guide plate 160 and an inner peripheral surface 171 of the frame 170. Most of the light L that has been emitted from the light source 180 and entered the end face 161 of the light guide plate 160 is totally reflected by the end face 161 toward the inside of the light guide plate 160, and the rest passes through the end face 161. The light emanating from the end face 161 of the light guide plate 160 enters the inner peripheral surface 171 of the frame 170. A part of the incident light is reflected and enters the light guide plate 160, and the rest passes through the inner peripheral surface 171 and enters the frame 170. Thus, due to the space 185 formed between the end face 161 of the light guide plate 160 and the inner peripheral surface 171 of the frame 170, most of the light L that has entered the end face 161 can be totally reflected, so that the optical loss can be reduced. Consequently, it is possible to suppress a reduction in brightness of the illuminating device.

On the other hand, similarly to the illuminating device shown in FIG. 5, FIG. 7B shows an optical path of light emitted from a light source (e.g., an LED) 180 in an illuminating device obtained by integrating a frame 170 with a light guide plate 160 by two-color molding. In this illuminating device, an end face 161 of the liquid guide plate 160 and an inner peripheral surface 171 of the frame 170 are joined together. Moreover, there is almost no refractive index difference between the light guide plate 160 and the frame 170. Therefore, most of the light L that has been emitted from the light source 180 and entered the interface between the light guide plate 160 and the frame 170 passes through the interface and enters the frame 170, causing an optical loss. If the interface between the end face 161 of the light guide plate 160 and the inner peripheral surface 171 of the frame 170 is not an even flat surface, the optical reflectance of the interface is reduced further, which also leads to an optical loss. Thus, when the frame 170 is brought into close contact with the light guide plate 160 without any gap between them by two-color molding, the optical loss is increased, and the brightness of the illuminating device is reduced.

In the illuminating device shown in FIG. 6, the spaces 142, 152 are formed between the light guide plate 140 and the frame 150. Therefore, similarly to FIG. 7A, most of the light that has entered the end faces of the light guide plate 140 that are in contact with the spaces 142, 152 can be totally reflected. However, since the upper surface of the flange portion 141 and the lower surface of the flange receiving portion 151 are joined together, most of the light that has entered the upper surface of the flange portion 141 enters the flange receiving portion 151, causing an optical loss. Accordingly, even in the case of the illuminating device shown in FIG. 6, the optical loss is increased, and the brightness of the illuminating device is reduced. Moreover, in order to ensure the strength of the flange portion 141 and the flange receiving portion 151, their thicknesses cannot be reduced. Therefore, it is difficult to reduce the thickness of the illuminating device.

It is an object of the present invention to solve the above problems of the conventional illuminating devices and to make the illuminating device and the display device thinner and lighter without reducing the strength and the brightness.

### Means for Solving Problem

An illuminating device of the present invention includes the following: a substantially rectangular light guide plate that includes at least one end face as a light incident surface; a frame that is arranged to surround the light guide plate; and a light source that is located between the light guide plate and the frame so as to face the light incident surface of the light guide plate. The light guide plate and the frame are integrally molded by two-color molding. At least a part of the end faces of the light guide plate except for the light incident surface is spaced from the frame.

A display device of the present invention includes the illuminating device of the present invention.

### Effects of the Invention

In the illuminating device of the present invention, the light guide plate and the frame are integrally molded by two-color molding. Thus, the strength can be improved compared to the conventional illuminating device obtained by the assembly of the light guide plate and the frame that have been separately produced. Consequently, the illuminating device can be made thinner and lighter.

On the other hand, at least a part of the end faces of the light guide plate except for the light incident surface is spaced from the frame. Thus, most of the light that has entered from the light guide plate to the portions of the end faces of the light guide plate that are spaced from the frame is totally reflected toward the inside of the light guide plate. Therefore, the optical loss can be reduced, and a reduction in brightness of the illuminating device can be prevented.

The display device of the present invention includes the above illuminating device, and thus can achieve a small thickness, lightweight, and bright screen while maintaining the necessary strength.

### BRIEF DESCRIPTION OF DRAWINGS

FIG. 1 is a cross-sectional view showing a schematic configuration of a liquid crystal display device according to an embodiment of the present invention.

FIG. 2A is a plan view showing a schematic configuration of a frame provided with a light guide plate constituting an illuminating device used in the liquid crystal display device in FIG. 1. FIG. 2B is an enlarged plan view of a portion 2B in FIG. 2A.

FIG. 3 is an enlarged plan view showing a frame provided with a light guide plate in the vicinity of a light source constituting a liquid crystal display device of the present invention.

FIG. 4 is an enlarged plan view showing another frame provided with a light guide plate in the vicinity of a light source constituting a liquid crystal display device of the present invention.

FIG. 5 is an exploded perspective view showing a conventional illuminating device.

FIG. 6 is a perspective view showing the main portion of another conventional illuminating device.

FIG. 7A shows an optical path of light from a light source in a conventional illuminating device in which a light guide plate and a frame are discrete components. FIG. 7B shows an optical path of light from a light source in a conventional illuminating device in which a frame is integrally formed around a light guide plate by two-color molding.

### DESCRIPTION OF THE INVENTION

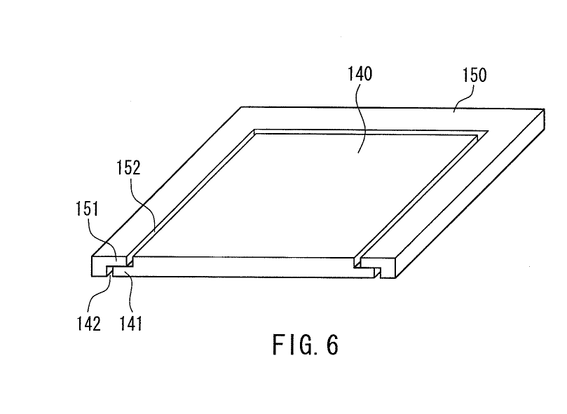

In the illuminating device of the present invention, the light guide plate and the frame are integrally molded by two-color molding, and at least a part of the end faces of the light guide plate except for the light incident surface is spaced from the frame. The configuration in which the light guide plate and the frame are “spaced” means that they are not in contact with each other. Therefore, as shown in FIG. 6, the configuration in which the light guide plate 140 and the frame 150 are joined in the thickness direction is excluded. Although the end faces of the light guide plate and the frame can be spaced in any portions as desired, it is preferable that those portions are determined in view of non-uniform brightness, strength, or the like of the illuminating device.

Specifically, it is preferable that the end faces of the light guide plate except for the light incident surface are joined to the frame in at least one corner portion of four corner portions of the substantially rectangular light guide plate, and are spaced from the frame in portions other than the at least one corner portion. The “corner portions” mean portions containing four vertices of the substantially rectangular light guide plate when the light guide plate is viewed from a direction perpendicular to the principal surface of the light guide plate. The light that propagates while being totally reflected in the light guide plate is likely to be collected at the corner portions. Therefore, even if the corner portions of the light guide plate are joined to the frame, a reduction in brightness in the corner portions can be relatively suppressed. Thus, the illuminating device with uniform brightness can be easily provided.

The light incident surface of the light guide plate may be joined to the frame except for a slot, into which the light source is inserted. This configuration can further improve the strength.

Alternatively, the light incident surface of the light guide plate may be spaced from the frame in the vicinity of a slot, into which the light source is inserted, so that light that has emitted from the light source and entered the light guide plate is totally reflected. This configuration can reduce the light entering from the light guide plate to the frame in the vicinity of the slot, and thus can further suppress a reduction in brightness of the illuminating device.

It is preferable that a concave curved surface is formed in a region of the frame that faces the light source. With this configuration, the light from the light source can be reflected by the concave curved surface into the light guide plate. Therefore, the optical loss can be reduced, and a reduction in brightness of the illuminating device can be suppressed further. Moreover, it is possible to suppress the occurrence of non-uniform brightness such that only the portion near the light source is particularly bright.

It is preferable that the light guide plate and the frame include the same material as the main component. With this configuration, the dimensional changes of the light guide plate are substantially the same as those of the frame due to environmental changes such as temperature and humidity. Therefore, the reliability of the illuminating device can be improved. The term “including as the main component” indicates including the component preferably in an amount of 50 wt % or more, and more preferably in an amount of 80 wt % or more.

Hereinafter, the present invention will be described in detail by way of a preferred embodiment. It should be noted that the present invention is not limited to the following embodiment. For convenience of explanation, each of the drawings that are to be referred to in the following description schematically shows only the main members required to describe the present invention, among the constituent members of the embodiment of the present invention. Therefore, the present invention can include any constituent members that are not shown in the following drawings. The size of and size ratio of each of the members in the following drawings do not exactly reflect those of the actual constituent members.

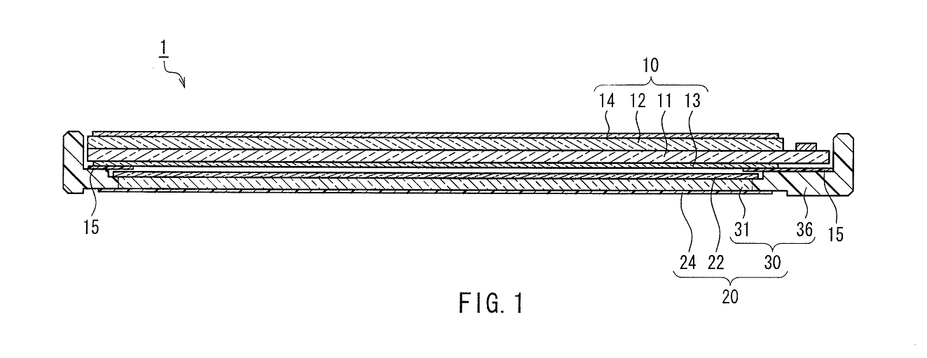

FIG. 1 is a cross-sectional view showing a schematic configuration of a liquid crystal display device 1 according to an embodiment of the present invention. The liquid crystal display device 1 includes a transmission type liquid crystal panel 10 that serves as a display portion, and an edge-light type illuminating device 20 that is located on the back of the liquid crystal panel 10 and illuminates the liquid crystal panel 10.

The liquid crystal panel 10 includes an active substrate 11 on which many pixel electrodes are arranged in a matrix, a counter substrate 12 on which transparent electrodes are formed so as to face the many pixel electrodes of the active substrate 11, and a liquid crystal (not shown) sealed between the two substrates 11, 12. The potential of each of the many pixel electrodes is controlled so that the passage of illumination light from the illuminating device 20 is controlled pixel by pixel. A deflection film 13 is formed on the surface of the active substrate 11 that faces away from the liquid crystal, and a deflection film 14 is formed on the surface of the counter substrate 12 that faces away from the liquid crystal. The liquid crystal panel 10 is fixed to a frame 36 with a double-sided tape 15.

The illuminating device 20 includes the following: a frame 30 provided with a light guide plate in which a light guide plate 31 and the frame 36 are integrated; an optical sheet 22 that is formed on the surface (light emission surface) of the light guide plate 31 that faces the liquid crystal panel 10; and a reflecting sheet 24 that is bonded to the surface of the light guide plate 31 that faces away from the liquid crystal panel 10.

The optical sheet 22 serves, e.g., to align the deflection direction or emission direction of light emanating from the surface of the light guide plate 31 that faces the liquid crystal panel 10 or to make the brightness uniform. The configuration of the optical sheet 22 is not particularly limited. For example, any optical sheet used for the illuminating device can be used. Moreover, the optical sheet 22 may be composed of either a single sheet or a plurality of sheets.

The reflecting sheet 24 allows the light that has leaked from the light guide plate 31 to reenter the light guide plate 31, thereby achieving the effective utilization of light. The configuration of the reflecting sheet 24 is not particularly limited. For example, any optical sheet used for the illuminating device can be used. Moreover, the reflecting sheet 24 may be composed of either a single sheet or a plurality of sheets.

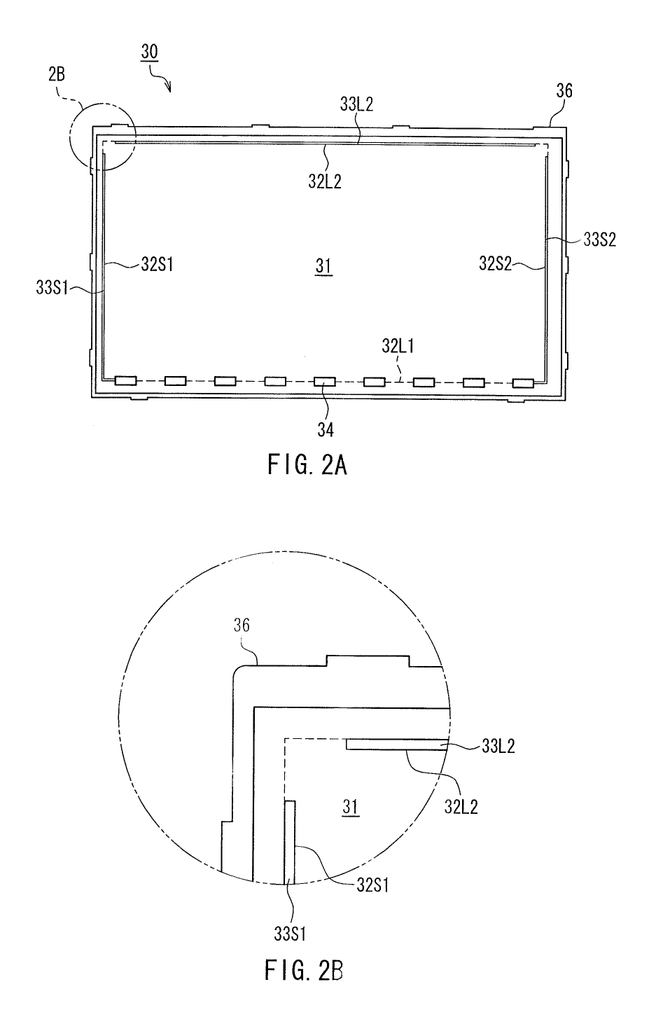

FIG. 2A is a plan view showing a schematic configuration of the frame 30 provided with a light guide plate. The frame 30 provided with a light guide plate includes the light guide plate 31 and the frame 36 that is integrally molded around the light guide plate 31 by two-color molding.

The light guide plate 31 is a plate-like body made of a transparent synthetic resin such as an acrylic resin (e.g., PMMA). The light guide plate 31 includes a pair of principal surfaces that are substantially rectangular in shape and face each other, and four end faces that are provided around the light guide plate 31 and connect the pair of principal surfaces. One of the pair of principal surfaces, i.e., the light emission surface faces the liquid crystal panel 10. Among the four end faces, a pair of end faces along the long sides of the light guide plate 31 are called long-side end faces 32L1, 32L2 and a pair of end faces along the short sides of the light guide plate 31 are called short-side end faces 32S1, 32S2.

The frame 36 is a substantially rectangular frame, and is located around the light guide plate 31 so as to face the four end faces 32L1, 32L2, 32S1, and 32S2 of the light guide plate 31. Although the material of the frame 36 is not particularly limited, it is preferable that the frame 36 includes the same material as the light guide plate 31 as the main component. With this configuration, the dimensional changes of the light guide plate 31 are substantially the same as those of the frame 36 due to environmental changes such as temperature and humidity. Therefore, the reliability of the illuminating device 20 can be improved. The frame 36 may include any additives such as a colorant (e.g., particles) as needed.

A plurality of slots 34 are formed at about the same pitch between the light guide plate 31 and the frame 36 along the long-side end face 32L1 of the light guide plate 31. The slots 34 are through holes, into which LEDs (not shown) are inserted as light sources of the illuminating device 20. In other words, the long-side end face 32L1 of the light guide plate 31 is the light incident surface on which light from the LEDs is incident. The light emitted from the LEDs enters the long-side end face 32L1 of the light guide plate 31, is diffused while being totally reflected in the light guide plate 31, and thus propagates. The diffused light emanates from the principal surface that faces the liquid crystal panel 10. The number of the slots 34 or the spacing between the slots 34 can be appropriately determined in accordance with the size or the like of the illuminating device.

There are spaces 33L2, 33S1, and 33S2 between the frame 36 and each of three end faces (i.e., the long-side end face 32L2 and the short-side end faces 32S1, 32S2) of the four end faces of the light guide plate 31 except for the long-side end face 32L1 (light incident surface). In FIG. 2A, the broken line indicates the boundary between the light guide plate 31 and the frame 36 that are joined by two-color molding.

FIG. 2B is an enlarged plan view showing a corner portion of the light guide plate 31 that is sandwiched between the long-side end face 32L2 (which is not a light incident surface) and the short-side end face 32S1, and the vicinity of the corner portion. As shown in FIG. 2B, the light guide plate 31 and the frame 36 are joined in the corner portion of the light guide plate 31, but spaced apart in the portions other than this corner portion. Although a detailed illustration is omitted, this is also true for a corner portion of the light guide plate 31 that is sandwiched between the long-side end face 32L2 and the short-side end face 32S2, and the vicinity of the corner portion.

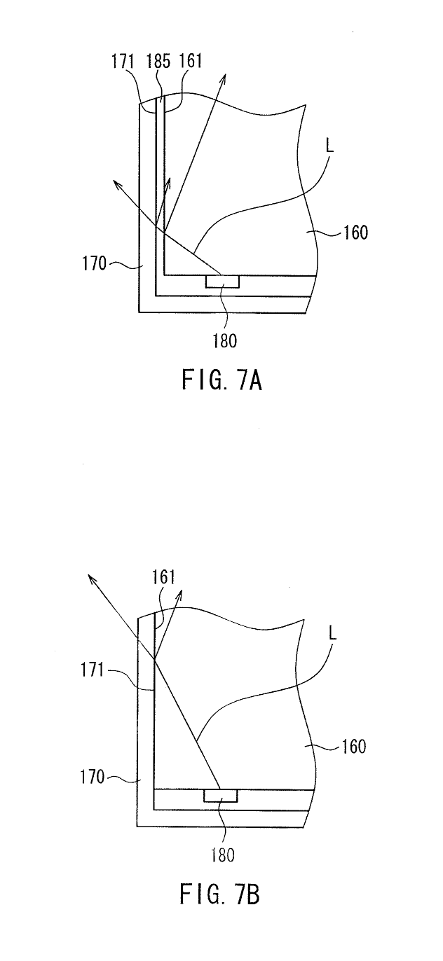

As described above, in this embodiment, the three end faces of the four end faces of the light guide plate 31 except for the long-side end face 32L1 (light incident surface) are spaced from the frame 36 other than the corner portions on both ends of the long-side end face 32L2 opposite the light incident surface. Thus, similarly to the explanation of FIG. 7A, most of the light that has entered from the LEDs to the light guide plate 31, and then has entered the portions of the end faces of the light guide plate 31 that are in contact with the spaces 33L2, 33S1, and 33S2 is totally reflected toward the inside of the light guide plate 31. Therefore, a reduction in brightness of the illuminating device 20 can be suppressed. Thus, it is possible to ensure the brightness comparable to that of the conventional illuminating device obtained by the assembly of the light guide plate and the frame that have been separately produced.

On the other hand, the light guide plate 31 and the frame 36 are joined by two-color molding except for the spaces 33L2, 33S1, and 33S2 and the slots 34. Therefore, the strength of the frame 30 provided with a light guide plate is improved, and the strength of the illuminating device 20 is also improved. Consequently, the illuminating device 20 can be even thinner and lighter. Moreover, since the width of the frame 36 can be reduced, the area around the display screen of the liquid crystal display device 1 (which is so-called “frame area”) can be narrowed.

The method of two-color molding of the light guide plate 31 and the frame 36 is not particularly limited. For example, first, the light guide plate 31 may be formed by primary molding with a primary molding die. Then, the frame 36 may be formed by secondary molding while the light guide plate 31 being placed in a secondary molding die so as to be integrated with the light guide plate 31.

It should be noted that the above embodiment is merely illustrative, and the present invention is not limited to the above embodiment and can be appropriately changed.

For example, the portion in which the light guide plate 31 and the frame 36 are spaced apart is not limited to the above embodiment. The light guide plate 31 and the frame 36 may be spaced apart in at least a part of the end faces of the light guide plate 31 except for the light incident surface (long-side end face 32L1). For example, the end faces around the light guide plate 31 may be spaced from the frame 36 in four corner portions, and joined to the frame 36 in the portions other than the four corner portions. However, in order to ensure uniform brightness of the light emission surface of the light guide plate 31, it is preferable that the light guide plate 31 and the frame 36 are generally joined in at least one corner portion of the four corner portions of the light guide plate 31, and spaced apart in the portions other than the at least one corner portion.

In the above embodiment, the light guide plate 31 and the frame 36 are spaced apart in the corner portions on both ends of the light incident surface (long-side end face 32L1). However, the light guide plate 31 and the frame 36 may be joined in these corner portions.

In the above embodiment, the light incident surface where the light source is located is only the long-side end face 32L1. However, the present invention is not limited thereto. The light incident surface may be any of the four end faces of the light guide plate 31. The light incident surface is not limited to one end face of the four end faces of the light guide plate 31, and two or three end faces of the four end faces of the light guide plate 31 can be used as the light incident surfaces. No matter which end face of the four end faces of the light guide plate 31 is the light incident surface, at least a part of the end faces other than the light incident surface may be spaced from the frame 36.

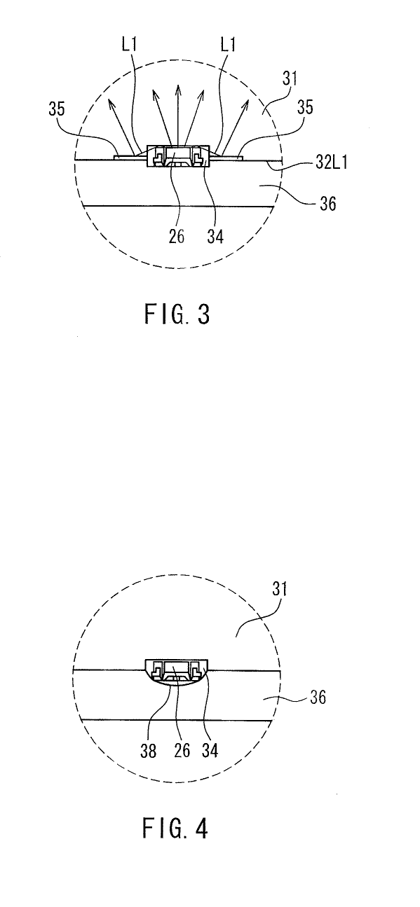

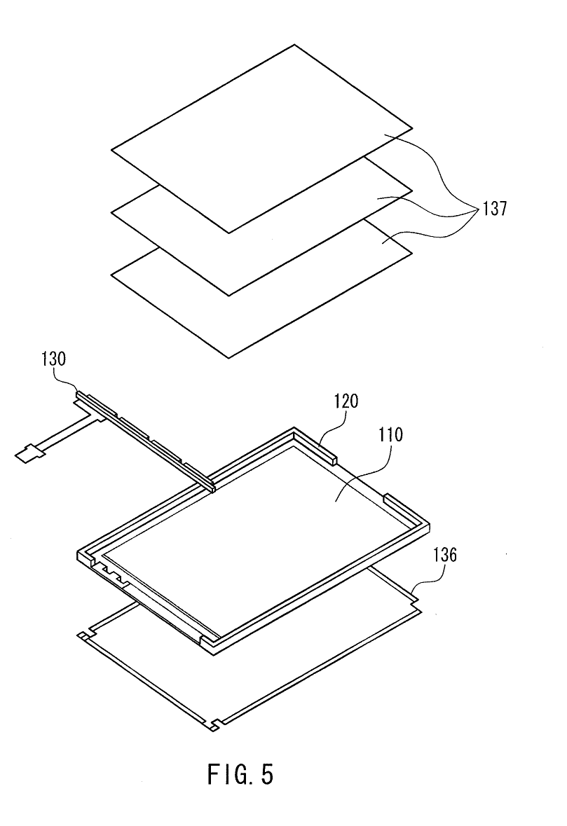

In the above embodiment, the portions of the light incident surface (long-side end face 32L1) of the light guide plate 31 other than the slots 34, into which the LEDs are inserted, are joined to the frame 36. This configuration increases the contact area between the light guide plate 31 and the frame 36, and thus is advantageous in improving the strength of the frame 30 provided with a light guide plate. However, the present invention is not limited thereto. For example, as shown in FIG. 3, a space 35 may be formed between the light guide plate 31 and the frame 36 in the vicinity of the slot 34, into which an LED 26 is inserted. With this configuration, the light L1 that has been obliquely emitted from the LED 26, reflected by the portion of the end face of the light guide plate 31 that faces the LED 26, and then entered the light guide plate 31 can be totally reflected by the portion of the end face of the light guide plate 31 that is in contact with the space 35. Therefore, the optical loss can be reduced, and the brightness of the illuminating device 20 can be improved. In FIG. 3, the space 35 is formed only in the vicinity of the slot 34. However, the space 35 may be formed to connect the adjacent slots 34.

As shown in FIG. 4, a concave curved surface 38 may be formed in a region of the frame 36 that faces the LED 26, i.e., the region of the frame 36 that constitutes the slot 34. The concave curved surface 38 can be any curved surface such as a cylindrical surface, a spherical surface, or an aspherical surface. The concave curved surface 38 is allowed to function as a reflecting surface that reflects the light emitted from the LED 26 to the surroundings toward the light guide plate 31. Therefore, the optical loss can be reduced, and the brightness of the illuminating device 20 can be improved. Moreover, it is possible to suppress the occurrence of non-uniform brightness such that only the portion near the LED 26 is particularly bright. In FIG. 4, the space 35 shown in FIG. 3 may be formed between the light guide plate 31 and the frame 36.

In the above embodiment, the LED is used as a light source. However, the light source of the present invention is not limited thereto, and any light sources such as discharge fluorescent tubes (a cold-cathode fluorescent tube, a hot-cathode fluorescent tube, a xenon fluorescent tube, etc.) and an EL cell can be used.

The illuminating device of the present invention may further include a member produced, e.g., by press molding of a metal plate in view of reinforcement, assembly performance of the display device, or the like.

The illuminating device of the present invention also can be used in applications other than the backlight device of the transmission type liquid crystal display device as described in the above embodiment. For example, the illuminating device can be applied to a film viewer for irradiating x-ray radiographs with light, a light box for irradiating negatives or the like with light to ensure better viewability, or an illuminating device for illuminating various signboards, advertisements, guide signs, etc. placed indoors or outdoors. The configuration of each portion of the illuminating device can be appropriately changed in accordance with the application of the illuminating device.

The display device of the present may include the illuminating device of the present invention, and also can be any display device that requires illumination light. The display device may display either dynamic images or static images.

All of the above-described embodiments are strictly intended to clarify the technical contents of the present invention. The present invention should not be interpreted as being limited to such specific examples, but should be broadly interpreted, and various modifications of the invention can be made within the spirit and scope of the invention as set forth in the appended claims.

### INDUSTRIAL APPLICABILITY

The field of industrial application of the present invention is not particularly limited, and the present invention can be suitably used particularly for a transmission type or semi-transmission type display panel.

1. An illuminating device comprising:
a substantially rectangular light guide plate that includes at least one end face as a light incident surface;
a frame that is arranged to surround the light guide plate; and
a light source that is located between the light guide plate and the frame so as to face the light incident surface of the light guide plate,
wherein the light guide plate and the frame are integrally molded by two-color molding, and
at least a part of end faces of the light guide plate except for the light incident surface is spaced from the frame.

2. The illuminating device according to claim 1, wherein the end faces of the light guide plate except for the light incident surface are joined to the frame in at least one corner portion of four corner portions of the substantially rectangular light guide plate, and are spaced from the frame in portions other than the at least one corner portion.

3. The illuminating device according to claim 1, wherein the light incident surface of the light guide plate is joined to the frame except for a slot, into which the light source is inserted.

4. The illuminating device according to claim 1, wherein the light incident surface of the light guide plate is spaced from the frame in a vicinity of a slot, into which the light source is inserted, so that light that has emitted from the light source and entered the light guide plate is totally reflected.

5. The illuminating device according to claim 1, wherein a concave curved surface is formed in a region of the frame that faces the light source.

6. The illuminating device according to claim 1, wherein the light guide plate and the frame include the same material as a main component.

7. A display device comprising the illuminating device according to claim 1.
